(19) United States
(12) Patent Application Publication
(10) Pub. No.: US 2008/0165078 A1
(43) Pub. Date: Jul. 10, 2008

(54) ANTENNA ASSEMBLY AND INFORMATION PROCESSING APPARATUS HAVING THE SAME

(75) Inventor: Young-shin SONG, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/844,488

(22) Filed: Aug. 24, 2007

(30) Foreign Application Priority Data
Jan. 5, 2007 (KR) 2007-1436

(51) Int. Cl. H01Q 1/50

(52) U.S. Cl. 343/906

(57) ABSTRACT

An antenna assembly of an information process apparatus includes an antenna connector which is mounted in the information process apparatus, at least one antenna which is selectably connected to the antenna connector, and a detector to detect a type of the at least one antenna if the antenna connector is connected to the at least one antenna.

### CROSS-REFERENCE TO RELATED APPLICATIONS

This application claims priority under 35 U.S.C. § 119(a) from Korean Patent Application No. 10-2007-0001436, filed on Jan. 5, 2007 in the Korean Intellectual Property Office, the disclosure of which is incorporated herein in its entirety by reference.

### BACKGROUND OF THE INVENTION

1. Field of the Invention

The present general inventive concept relates to an antenna assembly, and more particularly, to an antenna assembly to improve a configuration to replace, attach or detach an antenna, and an information processing apparatus having the same.

2. Description of the Related Art

A conventional information processing apparatus is conveniently used in daily life by generally processing various kinds of information and may include a portable computer.

Also, the conventional information process apparatus includes an MP3 player, a Personal Digital Assistant (PDA), a mobile phone, a digital camera, a digital photo frame and a Portable Multimedia Player (PMP).

Furthermore, the conventional information processing apparatus has at least one mounting slot through which a peripheral device such as a Secure Digital (SD) card and a Universal Serial Bus (USB) memory, etc., can be attached or detached. Also, a number and types of antennas receiving and transmitting information in the conventional information process apparatuses are increasing according to development and increase of new types of wireless solutions. Also, the antennas are built to be larger and structures of the antennas are variously formed.

However, the conventional information processing apparatuses have a difficulty in setting up the various antennas because of lack of space in a main body. Also, the conventional information processing apparatuses also have a problem in replacing antennas with various sizes and structures due to design restrictions.

### SUMMARY OF THE INVENTION

The present general inventive concept provides an antenna assembly which is capable of easily detecting a type of an antenna mounted thereon and changing a signal path, and an information processing apparatus having the same.

The present general inventive concept also provides an antenna assembly to easily change, attach or detach an antenna, and an information processing apparatus having the same.

The present general inventive concept also provides an antenna assembly to increase space efficiency of the antenna assembly, and an information processing apparatus having the same.

Additional aspects and/or utilities of the present general inventive concept will be set forth in part in the description which follows and, in part, will be obvious from the description, or may be learned by practice of the present general inventive concept.

The foregoing and/or other aspects and utilities of the present general inventive concept can be achieved by providing an antenna assembly of an information process apparatus, comprising an antenna connector which is mounted in the information process apparatus, at least one antenna which is selectably connected to the antenna connector, and a detector to detect a type of the at least one antenna if the antenna connector is connected to the at least one antenna.

The antenna assembly may further comprise a circuit converter to select an information transmitting path to transmit information received through the at least one antenna to the information process apparatus based on the type of the at least one antenna detected by the detector.

The detector may comprise at least one target member provided in one of the antenna connector and the at least one antenna, and at least one detecting member which is provided in the other one of the antenna connector and the at least one antenna to correspond to the target member so as to detect the type of the antenna.

The target member may be formed in the at least one antenna, and the detecting member may comprise a tact switch provided in the antenna connector.

The target member may be formed in the at least one antenna, and the detecting member may comprise a photo switch provided in the antenna connector.

The antenna may further comprise an antenna body, a casing to accommodate the antenna body, a signal pin to electrically transmit a signal from the antenna body, and a pin protect member to surround the signal pin.

The antenna connector may comprise a pin accommodator coupled with the signal pin and the pin protect member.

The antenna assembly may further comprise an auxiliary detect member provided in one of the at least one antenna and the antenna connector so as to detect whether the at least one antenna is connected to the antenna connector.

The antenna assembly may further comprise a rotation coupler to rotatably couple the at least one antenna with the antenna connector.

The rotation coupler may comprise a hooking member which is extended along a detaching direction of the at least one antenna in one of the at least one antenna and the antenna connector, and an engaging member which is engaged with the hooking member and provided in the other one of the antenna connector and the at least one antenna.

At least one of the hooking member and the engaging member may comprise a plurality of cut areas which are cut along the detaching direction of the at least one antenna.

The hooking member may be formed with a hooking projection, and the engaging member may be formed with an engaging groove engaged with the hooking projection.

The foregoing and/or other aspects and utilities of the present general inventive concept may also be achieved by providing an information process apparatus, comprising a main body, and at least one antenna assembly mounted in the main body to provide received information, the antenna assembly comprising an antenna connector which is connected to the main body, at least one antenna which is removably connected to the antenna connector, and a detector to detect a type of the at least one antenna if the antenna connector is connected to the at least one antenna.

The antenna assembly may further comprise a circuit converter to select an information transmitting path so as to transmit the information received through the at least one antenna to the main body based on the type of the at least one antenna detected by the detector.

The detector may comprise at least one target member provided in one of the antenna connector and the at least one antenna, and at least one detecting member which is provided in the other one of the antenna connector and the at least one antenna to correspond to the target member so as to detect the type of the at least one antenna.

The antenna assembly may further comprise an auxiliary detect member provided in one of the at least one antenna and the antenna connector to detect whether the at least one antenna is connected to the antenna connector.

The antenna assembly may further comprise a rotation coupler to rotatably couple the at least one antenna with the antenna connector.

The foregoing and/or other aspects and utilities of the present general inventive concept may also be achieved by providing an information processing apparatus, comprising a removable antenna removably connected to the information process apparatus, a detector to detect a type of the removable antenna when the removable antenna is connected, and a circuit converter to transmit information to the information processing apparatus based on the type of the removable antenna detected by the detector.

The circuit converter may switch an information transmitting path corresponding to the type of the removable antenna detected by the detector when the removable antenna is connected.

The detector may comprise a detecting member to transmit a signal to the circuit converter based on the type of the removable antenna, and a target member to control whether the detecting member transmits the signal.

The foregoing and/or other aspects and utilities of the present general inventive concept may also be achieved by providing an antenna assembly of an information processing apparatus, comprising an antenna connector mounted in the information processing apparatus to couple a removable antenna to the information processing apparatus, the antenna connector comprising a plurality of detecting members to each transmit a signal corresponding to a type of the removable antenna to the information processing apparatus when the removable antenna is coupled to the information processing apparatus.

The plurality of detecting members may be disposed in various locations in the antenna connector to correspond to various types of removable antennas.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view of an information processing apparatus according to an exemplary embodiment of the present general inventive concept;

FIG. 2 is a perspective view of an antenna assembly of FIG. 1;

FIG. 3 is a sectional view illustrating a main part of FIG. 2 according to an embodiment of the present general inventive concept;

FIG. 4 is a sectional view of FIG. 3 including an auxiliary detect member;

FIG. 5 is a sectional view to section the main part of FIG. 2 according to another exemplary embodiment of the present general inventive concept;

FIGS. 6A to 6D are sectional views illustrating assembly processes of the antenna assembly of FIG. 2; and

FIG. 7 is a schematic circuit switching a signal path of the antenna assembly of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

Hereinafter, an information processing apparatus is explained referring to the appended figures. The information processing apparatus may include a portable computer, Personal Digital Assistant (PDA), but only a portable computer will be explained as an example.

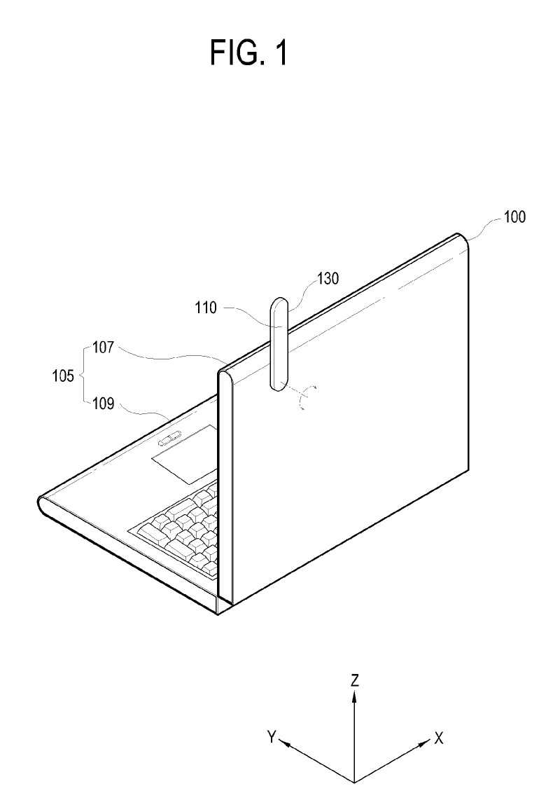

An information processing apparatus 100 of the present general inventive concept includes a main body 105 and an antenna assembly 110 having an antenna 130, as illustrated in FIGS. 1 to 7.

The main body 105 includes a display 107 to form an image thereon and an input part 109 through which various types of data are input. One of the display 107 and the input part 109 is coupled to an antenna 130 which corresponds to various types of wireless LANs. The antenna 130 corresponding to the wireless LAN may be mounted at a top or a side of the display 107 when the display 107 is unfolded to easily receive signals.

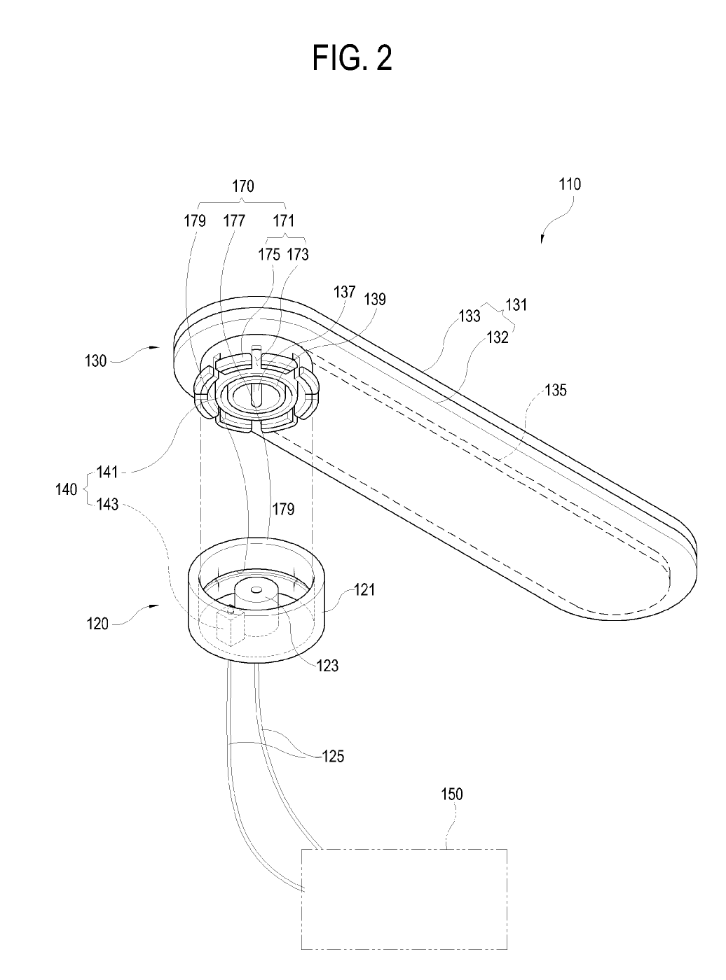

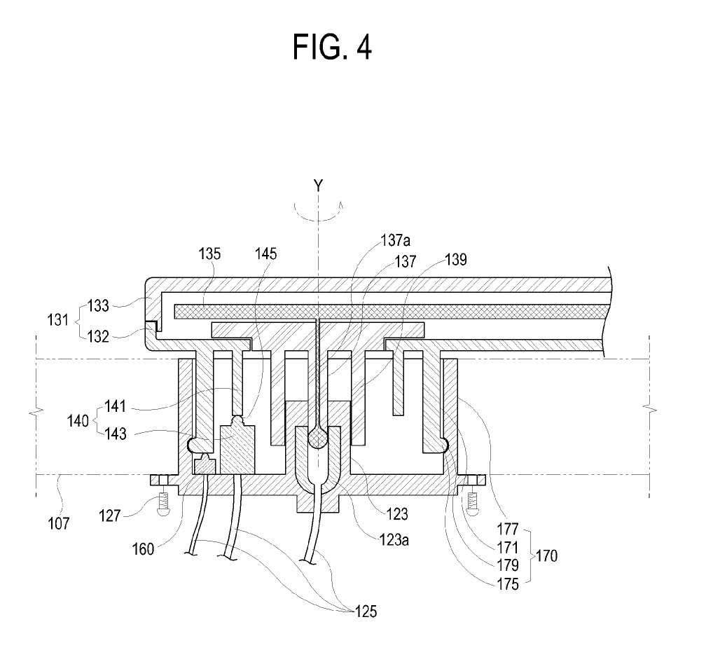

Referring to FIG. 2, the antenna assembly 110 includes an antenna connector 120, an antenna 130 and a detector 140. The antenna assembly 110 may further comprise a circuit converter 150, an auxiliary detect member 160 (as illustrated in FIG. 4), and/or a rotation coupler 170.

The antenna connector 120 has a connector body 121 and a pin accommodator 123. The antenna connector 120 may include various types of well known materials including plastic, metal, etc. The antenna connector 120 may include a component such as a cap to prevent from contacting dust or a foreign substance in a state that the antenna 130 is not connected thereto.

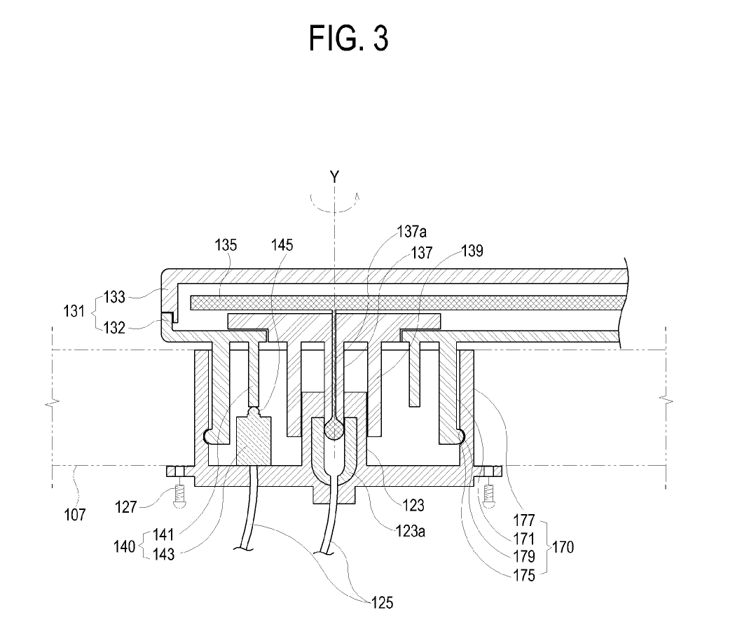

The connector body 121 is mounted in the display 107 by a connecting device including a screw 127 (as illustrated in FIG. 3), and is thereby connected to the antenna 130. The connector body 121 is formed with the pin accommodator 123 at a center portion of the connector body 121. An engaging member 177 extending from a flat surface is formed in an external area of the connector body 121.

A center portion of the pin accommodator 123 is depressed to accommodate an antenna pin 137, which may be disposed at a center portion of the rotation coupler 170. Also, a pin protect member 139, which has a cylindrical shape, surrounds and is coupled with the pin accommodator 123 by an external circumferential surface.

Referring to FIG. 3, the pin accommodator 123 includes a first conductor 123a to electrically connect the pin accommodator 123 with the antenna pin 137. The pin accommodator 123 may be formed to include the first conductor 123a, or the first conductor 123a may be the entire pin accommodator 123. Because the antenna 130 can rotate, the pin accommodator 123 may have a cylinder-shape. The first conductor 123a of the pin accommodator 123 is electrically connected to the circuit converter 150 by an inner cable 125.

The antenna 130 includes an antenna body 135. Further, the antenna 130 may include a casing 131, the antenna pin 137 and the pin protect member 139.

The antenna 130 may include at least one of various types of antennas which are respectively used for a wireless LAN, a Wireless Broadband Internet (WiBro), which is a wireless portable internet providing a high-speed internet connection that can be used while moving and a High Speed Downlink Access (HSDPA) of a 3.5 generation mobile communication method, etc. The antenna 130 may be provided in plurality, and hereinafter, the antennas 130 of the WiBro and the HSDPA will be described.

Herein, software through which information from the antenna 130 can be applied in the information process apparatus 100 is easily installed in the information process apparatus 100. The antenna body 135 and the antenna 130 may have various sizes, structures, types, and compositions thereof. For instance, undeveloped antenna 130 may be used in a communication unit to perform wireless communication of the information process apparatus 100

Referring to FIGS. 2 and 3, the casing 131 accommodates the antenna body 135, and includes a first casing 132 formed with a hooking member 171 and a second casing 133 coupled with the first casing 132 to form an exterior of the antenna 130 with the first casing 132 according to an exemplary embodiment. The first casing 132 and the second casting 133 may be coupled with each other by a well known coupling means such as a hook, a screw, etc.

The casing 131 is formed with a target member 141 extended from a flat surface of the casing 131 and having a short diameter relatively, and the hooking member 171 extended from the flat surface of the casing 131 and having a long diameter relatively according to the exemplary embodiment. The casing 131 is coupled with the antenna pin 137 according to the exemplary embodiment. The casing 131 may comprise a material such as plastic, etc. Herein, a size, a position and so on of the target member 141 and the hooking member 171 may be variously changeable.

Accordingly, various types of antenna bodies 135 may be accommodated in the casing 131 to be coupled with the antenna connector 120. Therefore, a user conveniently attaches and detaches the antenna 130 to use the antenna 130.

Referring to FIG. 3, the antenna pin 137 projects from the casing 131 and is electrically connected to the antenna body 135 through the inner cable 125 so as to transmit a signal received from the antenna body 135 to the antenna connector 120. The antenna pin 137 may include a second conductor 137a, or the second conductor 137a may be the entire antenna pin 137. The antenna pin 137 projects from the flat surface of the first casing 131 and may have a cylindrical shape, but may have other various shapes as necessary. The antenna pin 137 may be formed at a center portion of the hooking member 171, and provides a structure of the antenna pin 137 to prevent disconnection of an electrical connection between the antenna 130 and the antenna connector 120 if the antenna connector 120 is coupled with the antenna 130 and the antenna 130 rotates.

The pin protect member 139 is provided around the antenna pin 137 and protects the antenna pin 137. The pin protect member 139 maintains contact with the pin accommodator 123 so that the antenna pin 137 is stably connected in the antenna connector 120 while the antenna pin 137 is rotating.

Referring to FIGS. 2 and 3, the detector 140 includes the target member 141 and a detecting member 143. Herein, each of the target member 141 and the detecting member 143 may be provided in either the antenna connector 120 or the antenna 130, and hereinafter a description will be given of a case when the target member 141 is provided in the antenna 130 and the detecting member 143 is provided in the antenna connector 120.

The target member 141 projects from the flat surface of the antenna 130 between the hooking member 171 and the pin protect member 139 of the antenna 130, and may have a cylindrical shape. A position, material, etc., of the target member 141 may be variously changeable according to a size and type of the antenna 130, a couple structure of the detecting member 143, etc. A height of the target members 141 extending from the surface is uniform. Therefore, if the antenna 130 rotates after coupling with the antenna connector 120, the target member 141 may press the detecting member 143 stably as necessary. Herein, the target member 141 may be provided in plurality as necessary.

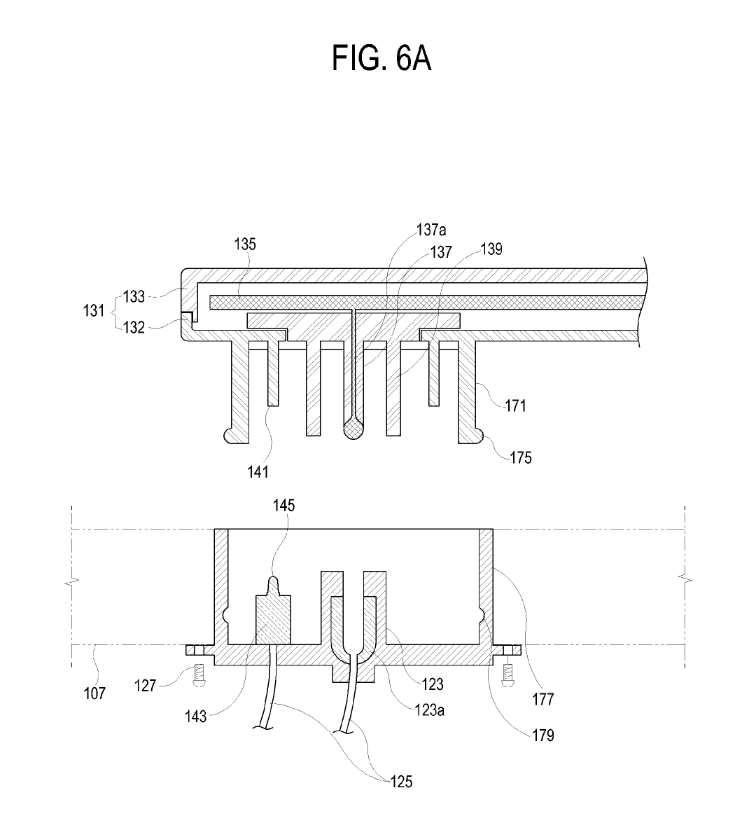

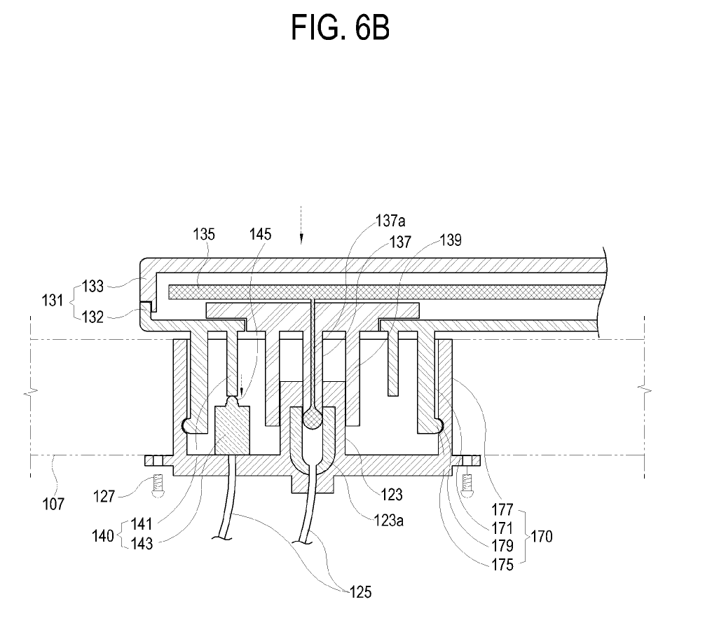

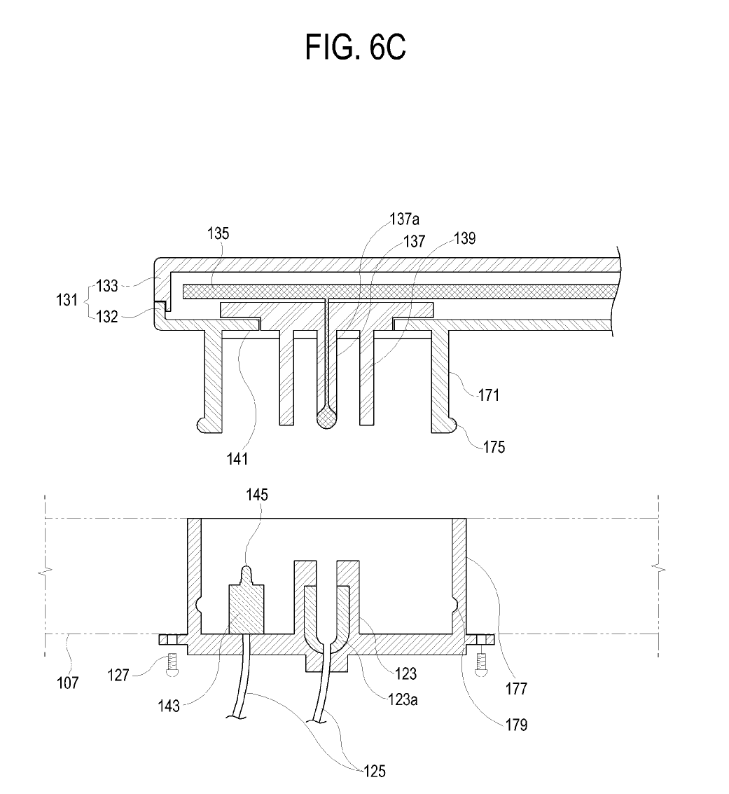

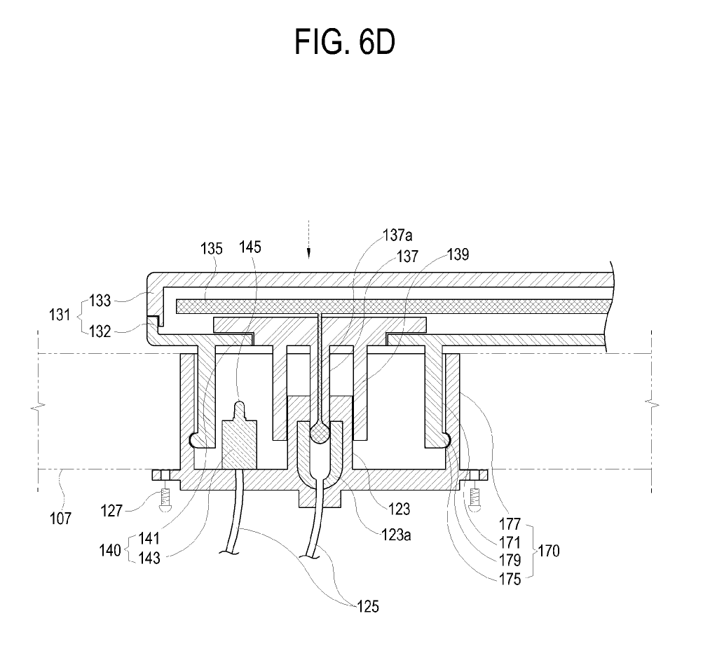

The shape of the target member 141 may be changed according to the type of the antenna 130. In other words, as illustrated in FIGS. 6A and 6B, the target member 141 may project from the flat surface of the casing 131 as described above according to an exemplary embodiment. Meanwhile, as illustrated in FIGS. 6C and 6D, the target member 141 may not project from the surface according to another exemplary embodiment. In other words, as illustrated in FIGS. 6A and 6B, if the target member 141 projects from the surface, the antenna 130 corresponding to WiBro may be coupled with the antenna connector 120. Also, as illustrated in FIGS. 6C and 6D, if the target member 141 does not project from the surface, the antenna 130 corresponding to HSDPA may be coupled with the antenna connector 120.

The detecting member 143 is coupled with the antenna connector 120 to correspond to the target member 141. The detecting member 143 is electrically connected to the circuit converter 150 by the inner cable 125 so as to transmit a detecting result detected in the detecting member 143 to the circuit converter 150. Therefore, the circuit converter 150 switches a circuit to correspond to the type of the antenna 130 connected to the antenna connector 120 based on the detecting result that is obtained when detecting the target member 141.

The detecting member 143 includes a tact switch 145 according to an exemplary embodiment. The detecting member 143 may be provided in plurality to correspond to a plurality of target members 141.

Hereinafter, an operation of the tact switch 145 and the detecting member 143 is described as follows. As illustrated in FIGS. 6A and 6B, the antenna connector 120 is connected to the antenna 130 corresponding to the WiBro, and the target member 141 presses the tact switch 145 to switch the detecting member 143 to be in a turned on state. Meanwhile, as illustrated in FIGS. 6C and 6D, if the antenna 130 corresponding to the HSDPA is connected to the antenna connector 120, the target member 141 does not press the tact switch 145, and therefore the detecting member 143 is in a turned off state.

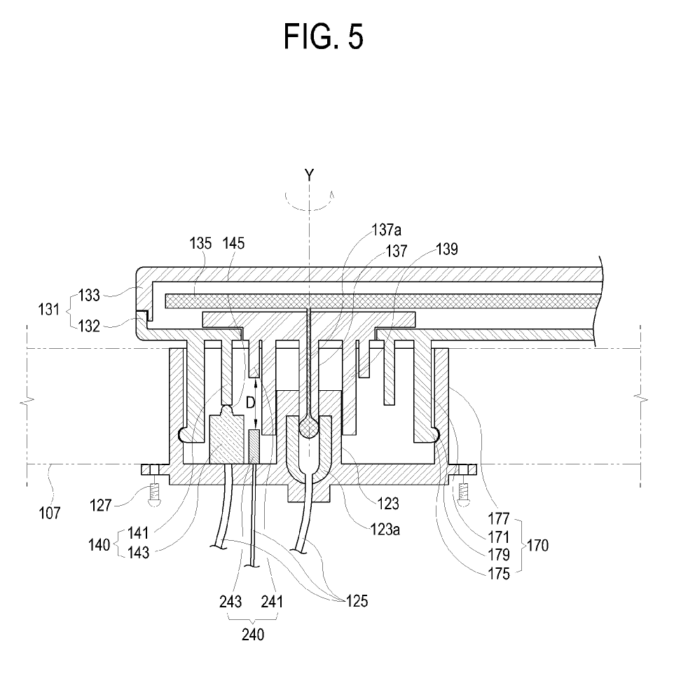

As illustrated in FIG. 5, the detecting member 143 may further include a photo detector 240 including a photo sensor 243 according to another exemplary embodiment. Herein, a plurality of target members 241 may extend in various heights from the flat surface of the casing 131, and information based on a distance (as denoted by “D” in FIG. 5) between a terminal of a target member 241 and the photo sensor 243 is transmitted to the circuit converter 150. Then, the circuit converter 150 may determine the type of the antenna 130 based on a comparison of a previously input value with a detected value from a detecting result of the detecting member 143. Also, the detecting member 143 may selectively include a known switching unit such as a magnetic switch, etc., as well as the tact switch 145 and the photo sensor 243.

Accordingly, the type of the antenna 130 connected to the antenna connector 120 is easily discerned by the detecting member 143 and the target member 141. Moreover, the information received through the antenna 130 is provided directly to the body 105, which increases user convenience.

The circuit converter 150 switches an information transmitting path to transmit the information received through the antenna 130 to the information process apparatus 100 based on the detecting result of the detector 140. Also, the circuit converter 150 may switch the information transmitting path after reflecting a result of the signal from the auxiliary detect member 160, as illustrated in FIG. 4, to determine whether the antenna connector 120 is connected with the antenna 130. The circuit converter 150 is provided in the body main 105.

Hereinafter, an operation process of the circuit converter 150 will be described.

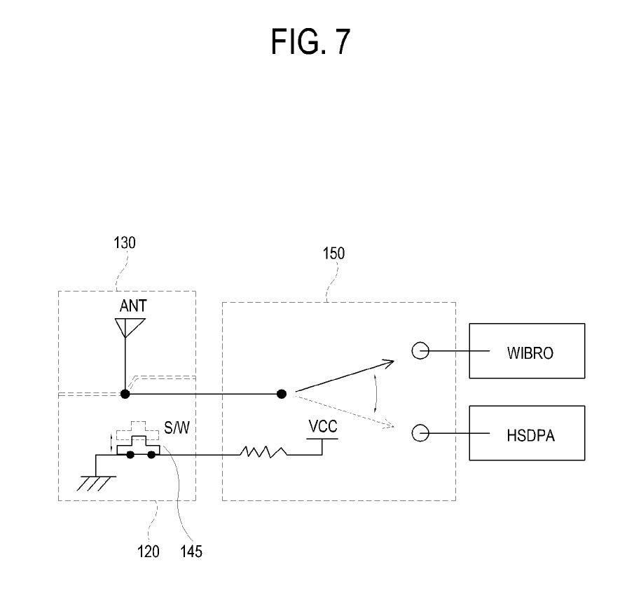

First, the antenna connecter 120 is connected to the antenna 130 to receive the information corresponding to WiBro. As illustrated in FIG. 6B, if the target member 141 presses the detecting member 143, the tact switch 145 is depressed and the detecting member 143 is turned on. Accordingly, as illustrated in FIG. 7, the detecting member 143 transmits a signal corresponding to the turned on state of the detecting member 143 to the circuit converter 150, and a voltage Vcc of a collector of a transistor in the circuit converter 150 switches a signal path to transmit the information corresponding to WiBro (e.g., a solid line in the circuit converter 150 of FIG. 7).

Meanwhile, the antenna connector 120 is connected to the antenna 130 to receive the information corresponding to HSDPA. As illustrated in FIG. 6D, the target member 141 does not press the detecting member 143, which causes the tact switch 145 to remain in a turned off state and thereby maintain the detecting member 143 in a turned off state. As illustrated in FIG. 7, a signal corresponding to the turned off state of the tact switch 145 is transmitted to the circuit converter 150, then a switch of the circuit converter 150 switches the signal path to transmit the information corresponding to HSDPA (e.g., a dotted line in the circuit converter of FIG. 7).

Herein, as illustrated in FIG. 4, if the auxiliary detect member 160 is provided, an auxiliary signal may also be used to control the circuit converter 150. In other words, as illustrated in FIG. 4, it can be determined whether the antenna 130 is connected or disconnected to the antenna connector 120. Also, if the antenna 130 is connected to the antenna connector 120, the type of the antenna 130 may be determined by the detecting member 143.

The auxiliary detect member 160 coupled with at least one antenna 130 and antenna connector 120 to detect whether the antenna 130 is connected to the antenna connector 120. The auxiliary detect member 160 may be connected to the antenna connector 120 which is adjacent to the circuit converter 150 to easily transmit the signal to the circuit converter 150. The auxiliary detect member 160 may include a known switching unit such as the photo switch, a magnetic switch, etc., as well as the tact switch 145 according to an embodiment of the present general inventive concept.

Accordingly, it may be easily determined whether the antenna 130 is mounted thereon.

The rotation coupler 170 includes the hooking member 171 and the engaging member 177.

The hooking member 171 may be provided in one of the antenna connector 120 and the antenna 130, and a description of when the hooking member 171 is formed in the antenna 130 will be provided.

Referring to FIG. 2, the hooking member 171 includes a hooking projection 175 and a cut area 173.

The hooking projection 175 is projected outwardly as a half circular shape at an end part of an outside circumference surface of the hooking member 171 according to an exemplary embodiment of the present general inventive concept. The shape of the hooking projection 175 may be variously provided to correspond to a shape of an engaging groove 179. Therefore, the hooking projection 175 is coupled with the engaging groove 179 to connect the antenna connector 120 to the antenna 130.

The cut area 173 is cut at a predetermined interval in a lengthwise direction from the flat surface of the antenna 130. The cut area 173 may have various lengths, widths, numbers, et., according to a size, a thickness, a material, etc., of the hooking member 171.

Therefore, the antenna 130 can be elastically attached and detached to the antenna connector 120.

The engaging member 177 is provided in one of the antenna connector 120 and the antenna 130, and hereinafter a description will be given when the engaging member 177 formed in the antenna connector 120.

The engaging member 177 is engaged with the hooking member 171 and includes the engaging groove 179. The engaging groove 179 is depressed in an inside circumferential surface of the engaging member 177 and is engaged with the hooking projection 175, so that the antenna connector 120 is strongly coupled with the antenna 130.

As described above, by providing a standard or commonly-shaped connection part such as the rotation coupler 170 through which the antenna 130 is connected to the antenna connector 120 in the antenna assembly, the antenna assembly 110 may be compatibly attached or detached to the antenna body 135 having various numbers, sizes, structures and types. Therefore, the information process apparatus 100 does not need to have the antenna 130 disposed in an inside portion thereof so that space efficiency of the main body 105 of the information process apparatus 100 can be improved, and the information process apparatus 100 may be designed with reduced restrictions due to the increased space efficiency.

Hereinafter, an assembly process of the antenna assembly 110 of an exemplary embodiment of the present general inventive concept with the information process apparatus 100 is described by referring to FIGS. 6A to 6D, and an operation process of the antenna assembly 110 is described by referring to FIG. 7.

Hereinafter, FIGS. 6A and 6B illustrate the antenna 130 which receives the information corresponding to WiBro, and FIGS. 6C and 6D illustrate the antenna 130 which receives the information corresponding to HSDPA.

First, as illustrated in FIG. 6A, the antenna 130 is provided to correspond to a position of the antenna connector 120 mounted in the display 107 of the main body 105. Next, as illustrated in FIG. 6B, if the antenna 130 is pressed toward the antenna connector 120, the hooking member 171 and the engaging member 177 are engaged with each other and the antenna 130 is rotatably connected to the antenna connector 120. At the same time, the target member 141 presses the tact switch 145 which causes the detecting member 143 to turn on by connecting the antenna connector 120 to the antenna 130. During the turned on state of the detecting member 143, the tact switch 145 is transmitted to the circuit converter 150 through the inner cable 125.

Therefore, the signal path in the circuit converter 150 is switched to follow the information transmitting path represented by the solid line of FIG. 7 by the voltage Vcc applied to the collector of the transistor in the circuit.

Accordingly, the antenna body 135 receives information corresponding to WiBro, and the information corresponding to WiBro is transmitted to the circuit converter 150 through the second conductor 137a of the antenna pin 137, the first conductor 123a of the pin accommodator 123, and the inner cable 125. Then, the circuit converter 150 transmits the information corresponding to WiBro to a module having WiBro software etc., to use the received information.

Meanwhile, as illustrated in FIG. 6C, the antenna 130 is provided to correspond to the position of the antenna connector 120 mounted in the display 107 of the main body 105. Next, as illustrated in FIG. 6D, if the antenna is pressed toward the antenna connector 120, the hooking member 171 and the engaging member 177 are engaged with each other and the antenna 130 is rotatably connected to the antenna connector 120. At this time, since the target member 141 does not press the tact switch 145, the detecting member 143 remains in a turned off state regardless of the connection of the antenna connector 120 and the antenna 130. During the turned off state of the detecting member 143, the tact switch 145 is transmitted to the circuit converter 150 through the inner cable 125.

Therefore, the circuit having the transistor in the circuit converter 150 selects the information transmitting path, which corresponds to the dotted line of FIG. 7, by not generating the voltage Vcc applied to the collector of the transistor in the circuit.

Accordingly, the antenna body 135 receives information corresponding to HSDPA and the information about HSDPA is transmitted to the circuit converter 150 through the second conductor 137a of the antenna pin 137, the first conductor 123a of the pin accommodator 123, and the inner cable 125. Then, the circuit converter 150 transmits the information about HSDPA to a module having HSDPA software, etc., to use the received information.

As described above, an information process apparatus according to an embodiment of the present general inventive concept may be applied to various information process apparatuses such as a PDA, a portable computer, etc.

Also as described above, various types of antennas 130 can be easily replaced, attached or detached to the information process apparatus according to an embodiment of the present general inventive concept.

An information transmitting path applied to the each of the various types of the antennas 130 may be changed at ease.

The present general inventive concept also allows a user to easily upgrade the antenna 130, thereby potentially reducing design restrictions of the information process apparatus.

Accordingly, space efficiency of the information process apparatus increase because various types of antennas can be easily replaced.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An antenna assembly of an information process apparatus, comprising:
an antenna connector mounted in the information process apparatus;
at least one antenna removably connectable to the antenna connector; and
a detector to detect a type of the at least one antenna if the antenna connector is connected to the at least one antenna.

2. The antenna assembly according to claim 1, further comprising:
a circuit converter to select an information transmitting path to transmit information received through the at least one antenna to the information process apparatus based on the type of the at least one antenna detected by the detector.

3. The antenna assembly according to claim 1, wherein the detector comprises:
at least one target member provided in one of the antenna connector and the at least one antenna; and
at least one detecting member provided in the other one of the antenna connector and the at least one antenna to correspond to the target member to detect the type of the antenna.

4. The antenna assembly according to claim 3, wherein:
the target member is formed in the at least one antenna; and
the detecting member comprises a tact switch provided in the antenna connector.

5. The antenna assembly according to claim 3, wherein:
the target member is formed in the at least one antenna; and
the detecting member comprises a photo switch provided in the antenna connector.

6. The antenna assembly according to claim 3, wherein the antenna further comprises:
an antenna body;
a casing to accommodate the antenna body;
a signal pin to electrically transmit a signal from the antenna body; and
a pin protect member to surround the signal pin.

7. The antenna assembly according to claim 6, wherein the antenna connector comprises:
a pin accommodator coupled with the signal pin and the pin protect member.

8. The antenna assembly according to claim 1, further comprising:
an auxiliary detect member provided in one of the at least one antenna and the antenna connector to detect whether the at least one antenna is connected to the antenna connector.

9. The antenna assembly according to claim 1, further comprising:
a rotation coupler to rotatably couple the at least one antenna with the antenna connector.

10. The antenna assembly according to claim 9, wherein the rotation coupler comprises:
a hooking member extending along a detaching direction of the antenna in one of the antenna and the antenna connector; and
an engaging member to engage with the hooking member and provided in the other one of the antenna connector and the at least one antenna.

11. The antenna assembly according to claim 10, wherein at least one of the hooking member and the engaging member comprise a plurality of cut areas which are cut along the detaching direction of the at least one antenna.

12. The antenna assembly according to claim 11, wherein:
the hooking member is formed with a hooking projection; and
the engaging member is formed with an engaging groove to engage with the hooking projection.

13. An information process apparatus, comprising:
a main body; and
at least one antenna assembly mounted in the main body to provide received information, the at least one antenna assembly comprising:
an antenna connector connected to the main body,
at least one antenna removably connectable to the antenna connector, and
a detector to detect a type of the at least one antenna if the antenna connector is connected to the at least one antenna.

14. The information process apparatus according to claim 13, wherein the at least one antenna assembly further comprises:
a circuit converter to select an information transmitting path to transmit the information received through the at least one antenna to the main body based on the type of the at least one antenna detected by the detector.

15. The information process apparatus according to claim 13, wherein the detector comprises:
at least one target member provided in one of the antenna connector and the at least one antenna; and
at least one detecting member provided in the other one of the antenna connector and the at least one antenna to correspond to the target member to detect the type of the at least one antenna.

16. The information process apparatus according to claim 13, wherein the at least one antenna assembly further comprises:
an auxiliary detect member provided in one of the at least one antenna and the antenna connector to detect whether the at least one antenna is connected to the antenna connector.

17. The information process apparatus according to claim 13, wherein the at least one antenna assembly further comprises:
a rotation coupler to rotatably couple the at least one antenna with the antenna connector.

18. An information processing apparatus, comprising:
a removable antenna removably connected to the information process apparatus;
a detector to detect a type of the removable antenna when the removable antenna is connected; and
a circuit converter to transmit information to the information processing apparatus based on the type of the removable antenna detected by the detector.

19. The information processing apparatus of claim 18, wherein the circuit converter switches an information transmitting path corresponding to the type of the removable antenna detected by the detector when the removable antenna is connected.

20. The information processing apparatus of claim 18, wherein the detector comprises:
a detecting member to transmit a signal to the circuit converter based on the type of the removable antenna; and
a target member to control whether the detecting member transmits the signal.

21. An antenna assembly of an information processing apparatus, comprising:
an antenna connector mounted in the information processing apparatus to couple a removable antenna to the information processing apparatus, the antenna connector comprising:
a plurality of detecting members to each transmit a signal corresponding to a type of the removable antenna to the information processing apparatus when the removable antenna is coupled to the information processing apparatus.

22. The antenna assembly of claim 21, wherein the plurality of detecting members are disposed in various locations in the antenna connector to correspond to various types of removable antennas.
